(19) United States
(12) Patent Application Publication
(10) Pub. No.: US 2005/0033917 A1
(43) Pub. Date: Feb. 10, 2005

(54) Computer system including a card medium controller and control method

(75) Inventor: Ken Takeuchi, Yokohama-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/855,120

(22) Filed: May 27, 2004

(30) Foreign Application Priority Data
May 30, 2003 (JP) 2003-154457

(51) Int. Cl. G06F 12/00; G06F 13/00

(52) U.S. Cl. 711/115; 710/301

(57) ABSTRACT

Compact Flash (CF) and other types of cards are compatible with the majority of modern computer systems and are operable in different operating modes to expand the function and capability of the computer system. Each operating mode may be preferable for different types of operations or functions. Support is provided by the present invention for each of the various operating modes within a single card slot. For example, in computer systems having a CF card slot, the CF card slot is set up such that a CF card mounted therein defaults to operating in a TrueIDE mode. When the CF card is installed or inserted in the CF card slot, it is checked to see whether the CF card is operable in the TrueIDE mode. If so operable, the CF card is controlled in the TrueIDE mode by an IDE controller. If it is not so operable, the CF card is controlled in the PC card mode by a PC card controller.

### BACKGROUND OF THE INVENTION

1. Field of the Invention

The present invention relates to various cards for attachment to a computer system and more specifically to a controller and control methods for advantageously operating the cards in various operation modes.

### BACKGROUND

Various card mediums may be used with a computer system such as a personal computer (PC) for memory expansion, data exchange, data communication and so on. Examples of standards for such card mediums include PC cards, CompactFlash^{ò} cards (hereafter, referred to as a “CF card”), SmartMedia^{ò} and so on.

The PC card is a unified standard for the card media for the personal computer laid down in collaboration by PCMCIA and the Japan Electronic Industry Development Association (JEIDA). Its applications are wide-ranging such as a flash memory card, a hard disk, a modem card, an SCSI card and an LAN card.

The CF card is the standard for a small-size memory card released by SanDisk Corporation. SmartMedia^{ò} is the standard for a stamp-sized flash memory card proposed by Toshiba Corp. These small-size memory cards were proposed as smaller-sized and lower-priced alternatives to the PC cards in are becoming popular in conjunction with the proliferation of digital cameras and portable information devices such as palmtop PCs and PDAs (Personal Digital Assistants).

Among these card medium standards, many provide a plurality of pin definitions and allow operations in a plurality of operation modes. For example, see the teachings in Published Unexamined Patent Application (PUPA) No. 2001-319209 (see FIG. 3, pp. 2 and 4), for instance.

In the case of the PC card discussed in PUPA No. 2001-319209, there is the operation mode determined by the PC Card Standard, such as 16-bit width memory card and I/O card, a 32-bit width CardBus PC card, and a DMA slave card and a ZV port-ready card as function enhancements of the I/O card.

As for the CF card, the following three operation modes may be supported.
1. PC Card Memory Mode
2. PC Card I/O Mode
3. TrueIDE Mode

Of these, the PC Card Memory Mode and the PC Card I/O Mode are PC card-compatible modes, and are not different from the PC card from the perspective of a PC card controller. However, the TrueIDE Mode is the same interface as a general hard disk, and is not compatible with the PC card.

The PC Card Memory Mode is the operation mode corresponding to a communication card, for instance. The PC Card I/O Mode and the TrueIDE Mode are the operation modes corresponding to a storage card. However, there is a difference in data transfer rate between the PC Card I/O Mode and the TrueIDE Mode. More specifically, the former is handled as a 16-bit I/O card of the PC card, and so the transfer rate defined by the 16-bit I/O card, that is, a speed equivalent to an ISA (Industrial Standard Architecture) bus, exists as a limit. On the other hand, by using the latter mode, it is possible to transfer data at a transfer rate much higher than the limits of the PC card.

As discussed above, the operating standards for the card medium allow the card medium to operate in a plurality of operation modes. However, at present, typical computer systems are not configured to or capable of controlling the card medium in all of the available operating modes.

For instance, a PC comprising a card slot dedicated to the CF card (hereafter, referred to as a “CF card slot”) has such a configuration. In that configuration, the PC card controller is used for the interface with the CF card slot, and a storage device is handled as the PC Card I/O Mode. The TrueIDE Mode capable of transferring the data at the high speed may not be used in that configuration. This is because the TrueIDE Mode cannot be mixed with another mode, that is to say, if the CF card slot is dedicated to the TrueIDE Mode, a general PC card-compatible CF card such as a data communication card no longer operates. This problem could be solved if the three modes can be simultaneously supported. This is currently impossible because, for example, the CF card is in the TrueIDE Mode if a ninth pin (Pin 9) is LOW at a start of a feed to itself, or in the PC card-compatible mode if not. For this reason, it must be determined which state Pin 9 should be in before inserting the CF card.

A PC comprising the CF card slot described above is very convenient especially when transferring a large amount of image data to the PC from, for example, a digital camera by directly exchanging the data with a CF storage device such as a Microdrive and so on without using a separate adapter card. However, when adopting a configuration wherein a PC card controller is used for the interface with the CF card slot and the CF storage device is handled as a PC card-compatible mode, it takes too much time for data transfer from a CF card to the PC. This is especially true in light of recent CF cards with increasingly high storage capacity, including the appearance of such storage devices having over 1 GB of capacity like the Microdrive, for instance.

While PUPA No. 2001-319209 discloses changing the operation mode of the PC card, it does not refer to controlling the PC card for operating in each operation mode with an adequate card medium control means as disclosed herein.

The present invention has been implemented in order to solve the above technical problems, and an object thereof is to control an installed card medium with an adequate card medium control means.

Another object is to implement such control with the card medium control means so as to be capable of transferring data from the card medium at a high rate of speed.

A further object is to improve a data transfer rate from an installed CF card to a computer system without decreasing the types and modes of operation of CF cards usable in the computer system's CF card slot.

### SUMMARY OF THE INVENTION

In order to achieve the above-stated objects, embodiments of the present invention are constituted to control the card medium using a plurality of card medium control means (card controllers), each comprising an adequate card medium control means. To be more specific, a computer control device according to the present invention comprises checking means for checking whether or not a predetermined card medium is operable in a first operation mode (see processing steps 104 to 105 of FIG. 3) and initialization means for setting the card medium to be operable in a second operation mode different from the first operation mode when the checking means determines that the card medium is not operable in the first operation mode (see processing steps 107 to 108 of FIG. 3).

Here, data can be transferred from the card medium at a higher speed when operating in the first operation mode than when operating in the second operation mode. The checking means may also perform the checking by issuing a test command to the card medium and examining its response.

Considering another embodiment of the present invention, a computer system comprises first card medium control means for controlling an installed card medium, second card medium control means for controlling an installed card medium in a different manner from the first card medium control means, and computer control means for checking whether or not the installed card medium is controllable by the first card medium control means. The computer control means further sets the card medium to be controlled by the second card medium control means when it is determined that the card medium is not controllable by the first card medium control means.

The computer control means may direct the first card medium control means to issue a test command to the card medium and perform the checking based on the response received from the card medium. The computer system may further comprise a first connection means for connecting the card medium to the first card medium control means, and a second connection means for connecting the card medium to the second card medium control means. When it is determined that the first card medium control means cannot control the card medium, the computer control means disconnects the first connection means and connects the second connection means. Furthermore, the computer system may further comprise acceptance means for accepting the card medium and initialization means for setting up the acceptance means so that the card medium is controlled by the first card medium control means on starting an operation.

As a more specific exemplary embodiment of the present invention, a computer system comprising a CF card slot has the CF card slot set up as dedicated to a TrueIDE mode by default. The system first tests an installed CF card as to whether it is operable in the TrueIDE mode. If it is not so operable, the card can be connected to a PC card controller instead. More specifically, a computer system according to such an embodiment comprises an IDE controller for controlling the CF card supporting the TrueIDE mode and a PC card controller for controlling the CF card supporting a PC card compatible mode. The system further comprises a computer control means for checking whether the installed CF card is operable in the TrueIDE mode. If the CF card is not so operable, it is set to be operable in the PC card compatible mode.

The computer control means may direct the IDE controller to issue a test command to the CF card and will perform the checking based on the response received from the CF card. The computer system may comprise a CF card slot capable of supporting the CF card in TrueIDE mode or in PC card compatible mode. The computer control means checks whether the installed CF card is operable in the TrueIDE mode, and, if it is not, sets up the CF card to operate in the PC card compatible mode.

Embodiments of a computer system in accordance with the present invention may further comprise a first bus switch for selectively connecting the CF card slot and the IDE controller and a second bus switch for selectively connecting the CF card slot and the PC card controller. When it is determined that the CF card is not operable in the TrueIDE mode, the computer control means disconnects the first bus switch and connects the second bus switch. The computer system may further comprise initialization means for setting up the CF card slot so that, on loading the CF card in the CF card slot, it defaults to operation in the TrueIDE mode.

Embodiments of the present invention may be comprehended as a card medium control method to be executed by a computer system. More specifically, the present invention includes the steps of checking whether the connected card medium is operable in a first operation mode (steps 104 to 105 of FIG. 3). When it is determined that it is not operable in the first operation mode, the present invention calls for setting the card medium for operation in a second operation mode different from the first operation mode (steps 107 to 108 of FIG. 3).

It is assumed that data may be transferred from the card medium at a higher speed when operating in the first operation mode than when operating in the second operation mode. Also, the checking may be performed by issuing a test command to the card medium and examining the response received.

Further embodiments of the present invention may be comprehended as a program to be executed by a computer system. More specifically, such program implements the functions of checking whether the installed card medium is operable in a first operation mode (the function of performing the processing of steps 104 to 105 of FIG. 3). When it is determined by the function of checking that the card medium is not so operable, setting up the card medium to operate in a second operation mode different from the first operation mode (the function of performing the processing of steps 107 to 108 of FIG. 3).

### BRIEF DESCRIPTION OF THE DRAWINGS

Embodiments of the present invention will be described in some detail in the following specification and with reference to the following figures in which like elements are referred to using like reference numbers and in which:

FIG. 1 is a schematic diagram of a computer system to which embodiments of the present invention are applied;

FIG. 2 is a block diagram of a CF card control portion in accordance with embodiments of the present invention;

FIG. 3 is a flowchart showing the processing of a card medium control method according to embodiments of the present invention;

FIG. 4 is a diagram showing one possible state of control of the CF card control portion of FIG. 2; and

FIG. 5 is a diagram showing another possible state of control of the CF card control portion of FIG. 2.

### DETAILED DESCRIPTION OF EMBODIMENTS OF THE PRESENT INVENTION

Hereinafter, the present invention will be explained by way of description of exemplary embodiments, however, these embodiments should not be read as limiting the invention's scope which shall be delineated solely by the claims appended hereto. In addition, all combinations of characteristics explained in these embodiments are not necessary for each implementation of the invention.

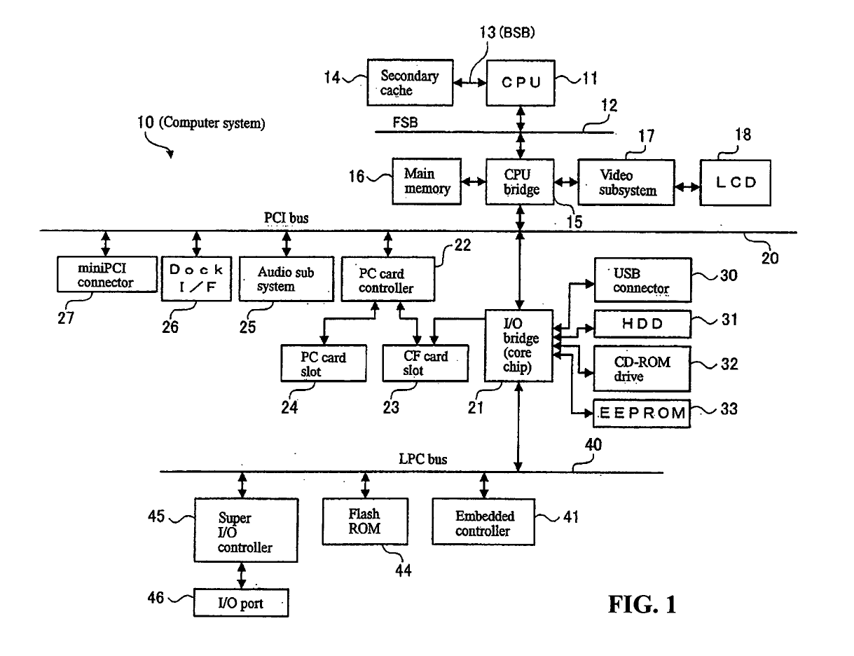

FIG. 1 is a diagram showing a hardware configuration of a computer system 10 to which this embodiment is applied. A computer system comprising the computer system 10 (hereafter, it may be referred to merely as a “system”) is constituted as a notebook-sized personal computer (notebook PC) on which a predetermined operating system (OS) in compliance with the OADG (Open Architecture Developer's Group) is installed.

In the computer system 10 shown in FIG. 1, a CPU 11 functions as brains of the entire computer system 10, and executes various programs in addition to utility programs under control of the OS. The CPU 11 is interconnected to various components via three-stage buses of an FSB (Front Side Bus) 12 as a system bus, a PCI (Peripheral Component Interconnect) bus 20 as a bus for a high-speed I/O device, and an LPC (Low Pin Count) bus 40 as a bus for an I/O device. The CPU 11 speeds up the processing by storing program codes and data in a cache memory. Although an SRAM of 128 K bytes or so is integrated as a primary cache inside the CPU 11 in recent years, a secondary cache 14 of 512K to 2 M bytes or so is placed via a BSB (Back side Bus) 13 as a dedicated bus in order to make up for shortage of capacity. It is also possible to omit the BSB 13, connect the secondary cache 14 to the FSB 12 and avoid a package of a large number of terminals so as to reduce costs.

The CPU 11 used here is capable of mode control, and can be operated in an ordinary mode and in a low power mode. As for a method of slowing down a working speed of the CPU 11, there are a SpeedStep technology of Intel Corporation, USA (for lowering an operating frequency and an operating voltage of a processor) and a throttling technology (for artificially lowering the operating frequency by periodically turning on and off the processor) for instance. It is possible, by operating the CPU 11 in the low power mode, to reduce a clock of the CPU 11 from ordinary 850 MHz to 750 MHz for instance and a voltage of the CPU 11 from ordinary 1.6 V to 1.35 V or so for instance.

The FSB 12 and the PCI bus 20 communicate with each other via a CPU bridge (host to PCI bridge) 15 called a memory/PCI chip. The CPU bridge 15 includes a memory controller function for controlling an access operation to a main memory 16, a data buffer for absorbing a difference in a data transfer rate between the FSB 12 and the PCI bus 20 and so on. The main memory 16 is a writable memory used as a read area of an executable program of the CPU 11 or a work area for writing processing data of the executable program, which is comprised of a plurality of DRAM chips for instance and comes equipped with 64 MB for instance to be added on up to 320 MB. This executable program includes various drivers for hardware-operating the OS and peripherals, application programs for specific jobs, and firmware such as BIOS (Basic Input/Output System) stored in a flash ROM 44 described later.

A video subsystem 17 is a subsystem for implementing a video-related function, and includes a video controller. The video controller processes a drawing instruction from the CPU 11 and writes processed drawing information to a video memory and also reads the drawing information from the video memory so as to output it as drawing data to a liquid crystal display (LCD) 18.

The PCI bus 20 is the bus capable of relatively high-speed data transfer, and is standardized by the specification in which a data bus width is 32 bits or 64 bits, a maximum operating frequency is 33 MHz or 66 MHz and a maximum data transfer rate is 132 MB per second or 528 MB per second. The PCI bus 20 has an I/O bridge 21, a PC card controller 22, an audio sub system 25, a docking station interface (Dock I/F) 26 and a mini PCI connector 27 connected thereto respectively.

The I/O bridge 21 comprises a bridge function of the PCI bus 20 and the LPC bus 40. It also comprises a DMA controller function, a programmable interrupt controller (PIC) function, programmable interval timer (PIT) function, an IDE (Integrated Device Electronics) interface function, a USB (Universal Serial Bus) function and an SMB (System Management Bus) interface function, and also contains a real time clock (RTC).

The DMA controller function is a function of performing the data transfer between the peripherals such as an FDD and the main memory 16 without mediation of the CPU 11. The PIC function is a function of causing a predetermined program (interrupt handler) to be executed in response to an interrupt request (IRQ) from the peripherals. The PIT function is a function of periodically generating a timer signal. An interface implemented by the IDE interface function has an IDE hard disk drive (HDD) 31 connected thereto and also has a CD-ROM drive 32 ATAPI (AT Attachment Packet Interface) connected thereto. It is possible to connect an IDE device of another kind such as a DVD (Digital Versatile Disc) drive thereto instead of the CD-ROM drive 32. External memory devices such as the HDD 31 and CD-ROM drive 32 are stored in a storage called a “media bay” or a “device bay” in the notebook PC proper. There are the cases where these external memory devices as standard equipment are mounted to be replaceable by other devices such as the FDD and a battery pack and exclusively. According to this embodiment, the I/O bridge 21 is connected to a CF card slot 23 by an IDE bus so that the controller for implementing the IDE interface function can directly control the CF card slot 23 described later.

Furthermore, a USB port is provided to the I/O bridge 21, and the USB port is connected to a USB connector 30 provided on a wall surface of the notebook PC proper for instance. The I/O bridge 21 has an EEPROM 33 connected thereto via an SM bus. The EEPROM 33 is a memory for holding information on a password, a supervisor password, a product serial number and so on registered by a user, which is nonvolatile and capable of electrically rewriting memory contents.

The PC card controller 22 is a controller dedicated to directly linking a bus signal of the PCI bus 20 to an interface connector (card bus) of the CF card slot 23 or a PC card slot 24. The CF card slot 23 can have the CF card loaded thereon, and the PC card slot 24 can have the PC card loaded thereon.

The audio sub system 25 is a chip (sound chip) for outputting sound, and creates the sound by a method of either an FM sound source or a PCM sound source. The FM method is a method whereby a tone is synthesized by combining a modulating signal called a “modulator” with a sinusoidal signal, and the PCM method is a method whereby a tone is generated by converting presence or absence and strength of the sound stored as digital data into waveform data. The docking station interface 26 is a piece of hardware for connecting a docking station (not shown) which is an extender of the computer system 10. If the notebook PC is set on the docking station, various hardware elements connected to an internal bus of the docking station are connected to the PCI bus 20 via the docking station interface 26. And the mini PCI connector 27 has a mini PCI card connected thereto.

The LPC bus 40 is an interface standard for connecting a legacy device to a system having no ISA bus, which exchanges a command, an address and data on a 33 MHz operation clock by using the same four signal lines (LAD signals) (if data for instance, 8 bits are transferred by 4 bits x 2 clocks). The LPC bus 40 has an embedded controller 41, a flash ROM 44 and a super I/O controller 45 connected thereto. It is also used to connect the peripherals operating at a relatively low speed such as a keyboard and a mouse controller.

The embedded controller 41 exerts control over the keyboard not shown and so on. According to this embodiment, however, it also exerts switching control over the controller for implementing the IDE interface function of the I/O bridge 21 and the PC card controller 22. The control over these controllers by the embedded controller 41 may be exerted by using GPIB (General Purpose Interface Bus).

The super I/O controller 45 has an I/O port 46 connected thereto for controlling driving of the FDD, parallel data input and output (PIO) via a parallel port, and serial data input and output (SIO) via a serial port. The flash ROM 44 is a ROM capable of electrically erasing and writing anew the data in a lump or block by block, and has the BIOS stored therein as described above.

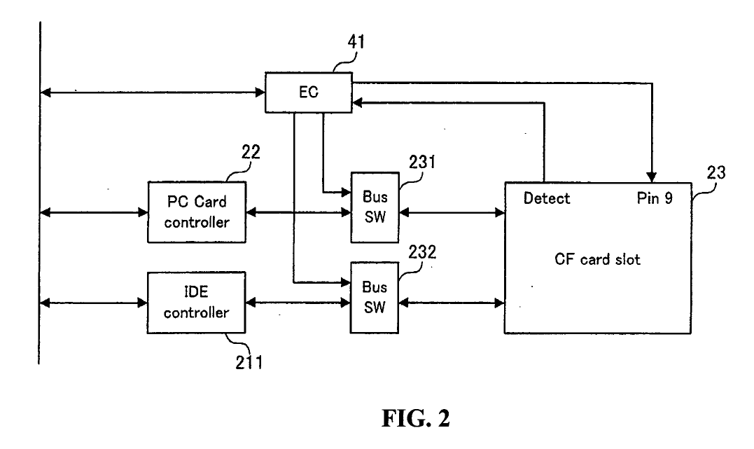

FIG. 2 is a block diagram showing only a portion related to this embodiment cut out of the hardware configuration shown in FIG. 1. In FIG. 2, the CF card slot 23 is connected to the PC card controller 22 and an IDE controller 211. The IDE controller 211 is a controller for implementing the IDE interface function which is a function of the I/O bridge 21 in the hardware configuration shown in FIG. 1.

A bus switch 231 is provided between the CF card slot 23 and the PC card controller 22, and a bus switch 232 is provided between the CF card slot 23 and the IDE controller 211. And the bus switches 231 and 232 are constituted to allow switching control by the embedded controller (EC) 41.

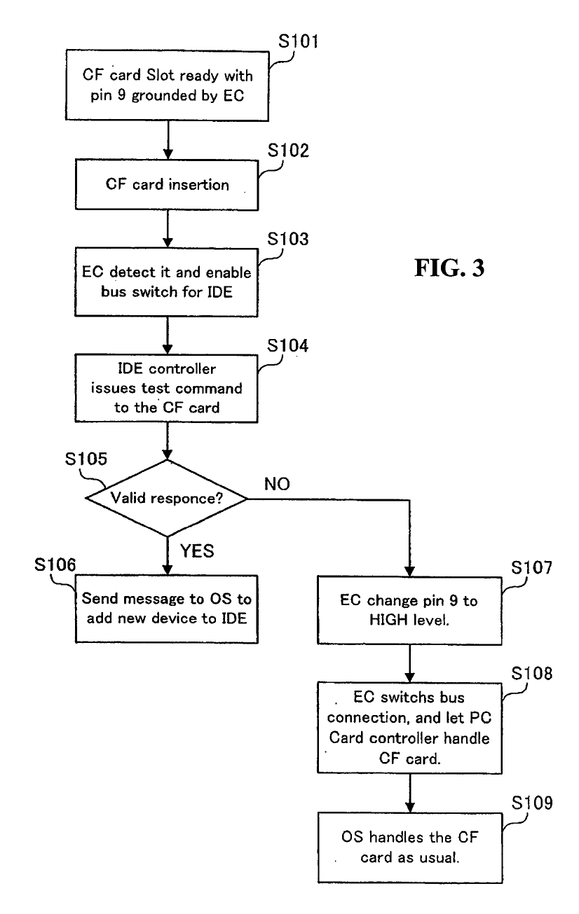

FIG. 3 is a flowchart showing the processing of a card medium control method according to this embodiment.

First, the EC 41 sets a Pin 9 of the CF card slot 23 at LOW by using GPO (step S101). And a CD# (Card Detect) signal is not directly connected to the PC card controller 22 so as to be detected by the EC 41 with another GPI pin.

The CF card is inserted in this state (step S102). On detecting insertion of the CF card, the EC 41 feeds the CF card while keeping the Pin 9 at LOW and resets it to set it in a TrueIDE mode. Next, the EC 41 enables the IDE bus (step S103), and directs the IDE controller 211 to test whether or not the CF card is recognizable as an IDE device. In response to this direction, the IDE controller 211 issues to the CF card a test command for testing whether or not it is operable in the TrueIDE mode (step S104).

Next, if there is no problem as to the test results (YES in step S105), the EC 41 informs the OS of the insertion of a new device (step S106). That operation is basically the same as the case of hot insertion of a new IDE device in an ultra bay. The test results are conveyed from the IDE controller 211 to the EC 41 via the LPC bus 40.

If there is a problem as to the test results (NO in step S105), that is, in the case of a response that the CF card is not recognizable in TrueIDE mode, the EC 41 sets the Pin 9 at HIGH to set the card in PC card compatible mode (step S107), and disables the IDE bus to disconnect it from the IDE controller 211.

Next, the EC 41 connects the CF card slot 23 to the PC card controller 22 and leaves handling of the CF card to the PC card controller 22 (step S108). Thus, the OS communicates with the CF card as a PC card (step S109).

The above processing flow will now be described by taking a concrete CF card as an example. First, a description will be given as to the case where the inserted CF card supports operation in the TrueIDE mode.

The EC 41 sets the Pin 9 of the CF card slot 23 at LOW (step S101). On insertion of the CF card (step S102), it feeds the CF card while keeping the Pin 9 at LOW and resets it to set it in a TrueIDE mode. Next, the EC 41 enables the IDE bus (step S103), and has it tested as to whether the CF card is recognizable by the IDE controller 211 as an IDE device (step S104).

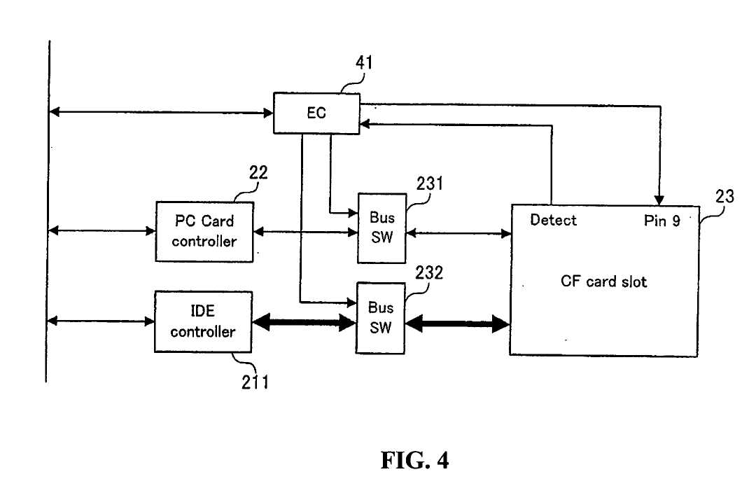

In this example, the CF card is recognizable as an IDE device (YES in step S105), and so the EC 41 determines that there is no problem as to the test results and informs the OS of the insertion of the new device (step S106). FIG. 4 shows the state of control of the CF card at this time. In FIG. 4, a heavy line represents that the IDE controller 211 controls the CF card.

Now, a description will be given as to the case where the inserted CF card does not support operation in the TrueIDE mode. This might be true, for example, when a PHS communication card is inserted into the CF card slot.

As before, the EC 41 sets the Pin 9 of the CF card slot 23 at LOW (step S101). On insertion of the CF card (step S102), it feeds the CF card while keeping the Pin 9 at LOW and resets it to set it in the TrueIDE mode. The EC 41 then enables the IDE bus (step S103), and has it tested as to whether the CF card is recognizable by the IDE controller 211 as an IDE device (step S104).

In this example, the CF card is unrecognizable as an IDE device (NO in a step S105), and so the EC 41 determines that there is a problem as to the test results and sets the Pin 9 at HIGH to set the card in a PC card compatible mode (step S107). EC 41 also disables the IDE bus to disconnect it from the IDE controller 211 and stops the power feed to the CF card once so as to connect the CF card slot 23 to the PC card controller 22.

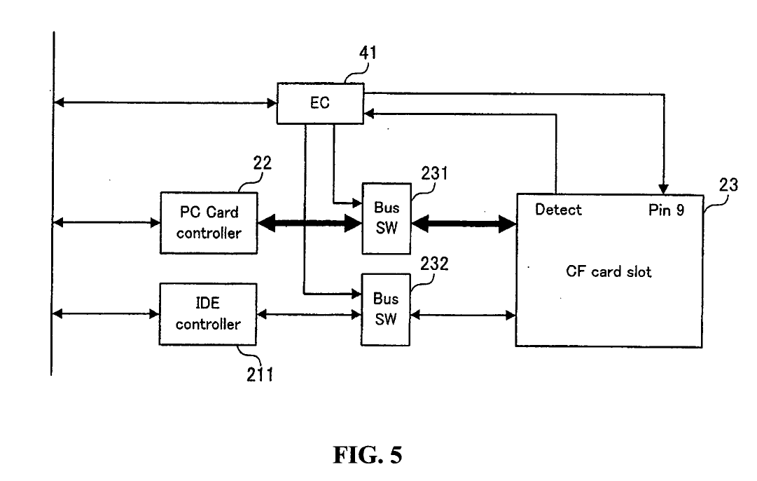

Communication with the CF card is then handled by the PC card controller 22 (step S108). Thus, the OS handles the CF card as the PC card as before (step S109). FIG. 5 shows the state of the control over the CF card at this time. In FIG. 5, the heavy line represents that the PC card controller 22 controls the CF card.

Thus, in accordance with this embodiment, the CF card slot 23 is set as dedicated to the TrueIDE mode, and connected to the IDE controller 211, by default. Any installed CF card is first tested to see if it is operable in the TrueIDE mode. If it is not so operable, it is connected instead to the PC card controller 22. Because of this configuration, any CF card supporting the TrueIDE mode operates in the TrueIDE mode, and so it is possible to improve the data transfer rate from the CF card loaded on the CF card slot 23 to the computer system. As for CF cards not supporting the TrueIDE mode, support is provided for automatic detection of such a situation including automatic adjustment for support of the card by the PC card controller 22. This ensures that all types of CF cards may still be supported by the CF card slot 23.

According to embodiments of the present invention, the EC 41 switches between the IDE controller 211 and the PC card controller 22. However, as will be apparent to those skilled in the relevant arts, means for performing such switching is not limited to the EC 41, but may be implemented by whatever means or apparatus is suitable for controlling both the controllers. And it is also possible to describe the processing to be performed by such means as a computer program and store it in storage means such as the main memory 16 and HDD 31 so that the computer program is read and executed by the CPU 11 to implement the above-mentioned functions.

According to the above, the PC comprises the CF card slot 23, and the CF card loaded thereon is controlled by the IDE controller 211 or the PC card controller 22. However, the CF card is not limited to the one loaded on the CF card slot 23 but may be the one remotely connected via some interface.

As for the card medium itself, the embodiments described above focused on CF cards. However, as will be apparent to those skilled in the relevant arts, the present invention is equally applicable to any card medium controllable by a plurality of card medium control means.

The present invention has been explained in some detail be describing one or more exemplary embodiments. However, it is to be understood that the scope of the present invention is not restricted to the range of the above-described embodiments. Those skilled in the relevant arts will readily recognize that various changes or modifications may be made to the described embodiments without departing from the scope and spirit of the present invention.

1. A computer control device comprising:
checking means for checking whether a card medium is operable in a first operation mode; and
initialization means for setting said card medium to be operable in a second operation mode different from said first operation mode when said checking means determines that said card medium is not operable in said first operation mode.

2. The computer control device according to claim 1, wherein data may be transferred from said card medium at a higher rate in said first operation mode than in said second operation mode.

3. The computer control device according to claim 1, wherein said checking means performs said checking by issuing a test command to said card medium and examining its response.

4. A computer system comprising:
first card medium control means for controlling an installed card medium;
second card medium control means for controlling an installed card medium in a different manner from said first card medium control means; and
computer control means for checking whether an installed card medium is controllable by said first card medium control means and for setting said card medium to be controlled by said second card medium control means when it is determined that said card medium is not controllable by said first card medium control means.

5. The computer system according to claim 4, wherein said computer control means;
directs said first card medium control means to issue a test command to said card medium, and
performs said checking based on a response to said test command from said card medium.

6. The computer system according to claim 4, further comprising:
a first connection means for connecting said card medium to said first card medium control means; and
a second connection means for connecting said card medium to said second card medium control means; and
wherein, in response to the determination that said first card medium control means cannot control said card medium, said computer control means disconnects said first connection means from said card medium and connects said second connection means to said card medium.

7. The computer system according to claim 4, further comprising:
acceptance means for accepting said card medium; and
initialization means for setting up said acceptance means so that said card medium defaults to being controlled by the first card medium control means on starting an operation.

8. A computer system comprising:
a CF card operable in at least one of a TrueIDE mode and a PC card compatible mode;
an IDE controller for controlling said CF card in said TrueIDE mode;
a PC card controller for controlling said CF card in said PC card compatible mode; and
computer control means for checking whether said CF card is operable in said TrueIDE mode and for setting said CF card to be operable in said PC card compatible mode when it is determined that said CF card is not operable in said TrueIDE mode.

9. The computer system according to claim 8, wherein said computer control means;
directs said IDE controller to issue a test command to said CF card, and performs said checking based on a response to said test command from said CF card.

10. The computer system according to claim 8, wherein:
said computer system comprises a CF card slot capable of accepting the CF card and of supporting the CF card in either the TrueIDE mode or the PC card compatible mode; and
said computer control means checks whether the CF card loaded in said CF card slot is operable in the TrueIDE mode and, when it is determined that the CF card is not operable in the TrueIDE mode, sets up the CF card to operate in the PC card compatible mode.

11. The computer system according to claim 10, further comprising:
a first bus switch for selectively connecting said CF card slot and said IDE controller; and
a second bus switch for selectively connecting said CF card slot and said PC card controller; and
wherein, in response to the determination that said CF card is not operable in the TrueIDE mode, said computer control means disconnects said first bus switch and connects said second bus switch.

12. The computer system according to claim 10, further comprising initialization means for setting up said CF card slot so that, on loading said CF card in said CF card slot, it defaults to operation in the TrueIDE mode.

13. A card medium control method executed by a computer system configured to be connectable to a card medium, comprising:
checking whether or not said connected card medium is operable in a first operation mode; and
in response to a determination that the card medium is not operable in said first operation mode, setting up said card medium to operate in a second operation mode different from said first operation mode.

14. The card medium control method according to claim 13, wherein data may be transferred from said card medium at a higher speed when operating in said first operation mode than when operating in said second operation mode.

15. The card medium control method according to claim 13, further comprising issuing a test command to said card medium and wherein said checking is performed based on a response to said test command received from said card medium.

16. A computer-readable medium comprising computer-readable program instructions embodied thereon, said computer-readable program instructions comprising instructions effective when executing on a suitable computer system to:
check whether or not a card medium connected to said computer system is operable in a first operation mode; and
in response to the determination that it is not operable in said first operation mode, initialize said card medium to operate in a second operation mode different from said first operation mode.
